(19) United States
(12) Patent Application Publication
(10) Pub. No.: US 2009/0283519 A1
(43) Pub. Date: Nov. 19, 2009

(54) Disposable microwave protector

(76) Inventor: Gloria Newton, Seattle, WA (US)

Correspondence Address: CHARLES J RUPNICK, PO BOX 46752, SEATTLE, WA, 98146, US

(21) Appl. No.: 12/387,778

(22) Filed: May 7, 2009

Related U.S. Application Data
(63) Continuation-in-part of application No. 10/372,562, filed on Feb. 21, 2003.

(51) Int. Cl. H05B 6/80

(52) U.S. Cl. 219/734

(57) ABSTRACT

A disposable arcuate sheet of an air permeable, water absorbent and hypoallergenic garment interfacing fabric and method for using the sheet for protecting microwave ovens against food spills, splashes, spatters and spitting during rotation of a carousel. The disposable sheet being a single layer of conventional interfacing fabric provided in a unbroken and unfolded substantially round or circularly shaped flat pattern sized either to cover a rotating carousel of a square or rectangular microwave oven, or to cover a food container in the oven, without substantially interfering with the oven walls during rotation of the carousel.

This application is a Continuation-in-part and claims priority benefit of copending parent U.S. patent application Ser. No. 10/372,562 filed in the name of Gloria Newton on Feb. 21, 2003, the complete disclosure of which is incorporated herein by reference.

### FIELD OF THE INVENTION

The present invention relates to splatter protection devices and methods, and in particular to disposable splatter protection devices and methods for use with rotatable carousels in microwave ovens.

### BACKGROUND OF THE INVENTION

The problem of food splatter during microwave cooking in uncovered containers is well-known, as are container covers for containing the splatter. One well-known disposable device for splatter protection is the sheet of conventional paper toweling that can be placed under or over a dish to capture and absorbent food spatters. However, interiors of microwave ovens are generally and small paper towels are invariably square or rectangular in shape so that the corners of the paper towel interferes with the walls when food is cooked on a rotating carousel. The cook must attempt to fold the corners of the paper towel under the container or dish so that it is not dislodged through interference with the walls during rotation of the carousel.

It is also known to wrap the container or dish in multipurpose plastic kitchen wrap or waxed paper sheeting. Each of these, however, have all of the drawbacks of paper toweling and must be folded around the container or dish so that it is not dislodged through interference with the walls during rotation of the carousel. Furthermore, each of these solutions suffers the limitations that spilled or over-boiled liquid cannot be absorbed, and when the food to be cooked or reheated is excessively heated, the plastic and wax tend to melt to the dish.

Other prior art devices are generally directed toward either structurally rigid, reusable lids or fabric composites designed to enhance the microwave action. Microwave ovens present special problems due to the rotation on a carousel of the container during cooking.

U.S. Pat. No. 4,721,140, entitled COVER DEVICE FOR PREVENTING SPATTERS DURING THE HEATING OF FOOD, for example, discloses a screen device that is adapted to cover a container or plate of food during heating, especially in microwave ovens. The screen device is formed as a sheet of open weave material, preferably polyester, and a plurality of plastic weight elements are secured to the peripheral margin of the sheet for holding the corners of the sheet out of the way during rotation on a carousel.

U.S. Pat. No. 4,797,523, entitled COVER FOR AN OPEN CONTAINER, WHOSE CONTENT IS TO BE HEATED IN A MICROWAVE OVEN, discloses around “cap” of cellulose hydrate film having ventilation holes, which is intended for use in covering otherwise open topped containers of various sizes and shapes, in which the contents are to be heated in a microwave oven. The cap-shape is intended to prevent interference with the microwave walls during rotation on a carousel.

U.S. Pat. No. 4,801,773, entitled SHROUD TO COVER DISH IN MICROWAVE OVEN, discloses another protective cover for a dish being heated in a microwave oven. The protective cover is formed of moisture-absorbent, microwave transparent material forming a top member and an encircling wall member depending downwardly from the periphery of the top member to completely cover the dish. The encircling wall member is intended to protect the interior of the oven from any possible spattering of food particles during the heating. The cover is formed of absorbent material that is intended to capture or absorb any escaping fluids and food particles. The wall member is fluted which is intended to give the cover self-supporting rigidity, and an upper edge of each fluted portion coincides with a scalloped portion of the top member. The cover may be treated with a microwave safe resin, which may increase the rigidity of the cover.

U.S. Pat. No. 6,100,514, entitled COVER FOR MICROWAVABLE CONTAINERS, discloses a cover for microwavable containers that is formed of a composite of textile materials which are intended to enhance microwave cooking. One layer provides insulation to hold heat within the microwavable container, while another retards splattering. The device is intended to allow steam ventilation from the container without the requirement of lifting a corner of the container, or otherwise taking steps to provide ventilation. The cover has an elastic perimeter which allows the cover to be placed over the container, with the elastic holding the cover in place against the container, and allows the cover to fit a range of variously sized and shaped microwavable containers. The cover is intended to be machine washable.

While these and other devices and methods may protect the microwave oven from food splatters, they are generally more complicated than necessary and are overly limited in functionality.

### SUMMARY OF THE INVENTION

The present invention provides a disposable arcuate sheet that overcomes many of the limitations of the known disposable splatter protection devices and methods of the prior art for protecting microwave ovens against food spills, splashes, spatters and spitting during rotation of a carousel by providing a round or circularly shaped protector formed of a air permeable, water absorbent and hypoallergenic fabric sized either to cover a rotating carousel of a square or rectangular microwave oven or to cover a dish in the oven without substantially interfering with the oven walls during rotation of the carousel. Accordingly, the disposable arcuate sheet of the invention consists exclusively of exactly one single layer of flat unbroken and unfolded substantially round monolithic and continuous sheet of conventional garment interfacing fabric that is air permeable, water absorbent, hypoallergenic and that remains resistant to tearing, when damp or even sopping wet. The hypoallergenic nature of interfacing fabric ensures that food will not be contaminated.

The round sheet of the invention thus provides protection for the interior of a microwave oven from liquid and food damage in a form unknown in the prior art. The sheet is formed in a novel unbroken substantially round flat pattern sized to lie directly on the carousel or atop an open dish of food within a square or rectangularly shaped microwave oven during rotation of the carousel. The sheet is thus easily placed on the carousel beneath a dish without resort to any folding or careful placement required of prior art devices. When placed on the carousel beneath a dish, the novel shape of the sheet provides a multipurpose microwave oven splatter protector that completely eliminates folding to underlie the dish to avoid interfering with the carousel mechanism, and thereby eliminates opportunities for damage to the carousel mechanism.

When placed on the carousel beneath a dish or atop an open dish of food, the novel shape of the microwave oven splatter protector also completely contains spilled, splashed, spit, splattered or over-boiled liquids from reaching the walls of the oven compartment by wicking, and thereby eliminates messes within the oven compartment.

Furthermore, because the novel round shape of the multipurpose microwave oven splatter protector completely eliminates interference with the oven compartment walls, dislodging of the splatter protector is also completely eliminated without resort to tucking under or around the dish or otherwise capturing the sheet to avoid such interference.

The novel shape of the multipurpose microwave oven splatter protector also permits quick, easy one-handed placement atop any open dish of food, without resort to choosing between the different sized covers provided in by prior art devices

The combination of the unbroken and unfolded substantially round flat-pattern with the hypoallergenic, air permeable, water absorbent interfacing fabric permits the multipurpose microwave oven splatter protector sheet to be manufactured without any cutting, folding or connecting steps of the prior art being applied to the round sheet. The novel combination of the unbroken and unfolded substantially round sheet with the interfacing fabric thus results in manufacture of the splatter protector sheet with far fewer steps than prior art devices, and far fewer parts relative to many prior art splatter protection devices.

Novel use of the garment interfacing fabric provides many of the advantages of prior art splatter protection devices, while eliminating the need for the multiple layers of different materials used in prior art devices.

According to one aspect of the invention, novel selection of the sheet of garment interfacing fabric render the splatter protection device of the invention disposable.

According to another aspect of the invention, the multipurpose microwave oven splatter protector sheet is formed of a fabric that, while disposable, may also be washed and dried by conventional means.

According to another aspect of the invention, the garment interfacing fabric further is formed of one or more of polyester, rayon and nylon fibers, the fibers being non-woven and distributed at random and being held together by chemical binders and heat.

According to another aspect of the invention, the multipurpose microwave oven splatter protector sheet is sized to be one of 10¼ inches and 13¼ inches in diameter. The multipurpose microwave oven splatter protector sheet is therefore sized to operate with a conventionally sized rotatable carousel of a conventionally sized microwave oven, the circular sheet of fabric extending into close proximity with the oven walls and closed door of the microwave oven without effectively interfering therewith during rotation of the carousel.

According to still other aspects of the invention, a method is provided for using the multipurpose microwave oven splatter protector sheet to protect a microwave oven against food spills, splashes, spatters and spitting during microwave heating of food positioned on a rotatable carousel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a plan view of the multipurpose microwave oven splatter protector of the invention embodied as a round sheet; and

FIG. 2 is a side view of the multipurpose microwave oven splatter protector of the invention of FIG. 1.

### DETAILED DESCRIPTION OF PREFERRED EMBODIMENT

In the Figures, like numerals indicate like elements.

The present invention is disposable multipurpose microwave oven splatter protector sheet and method for protecting a microwave oven from liquid and food damage. The disposable contour sheet consists exclusively of exactly one single monolithic layer of substantially round, flat, continuous and unbroken sheet of hypoallergenic garment interfacing fabric sized to cover completely an upper surface of a microwave rotation carousel, without extending to touch the interior compartment walls.

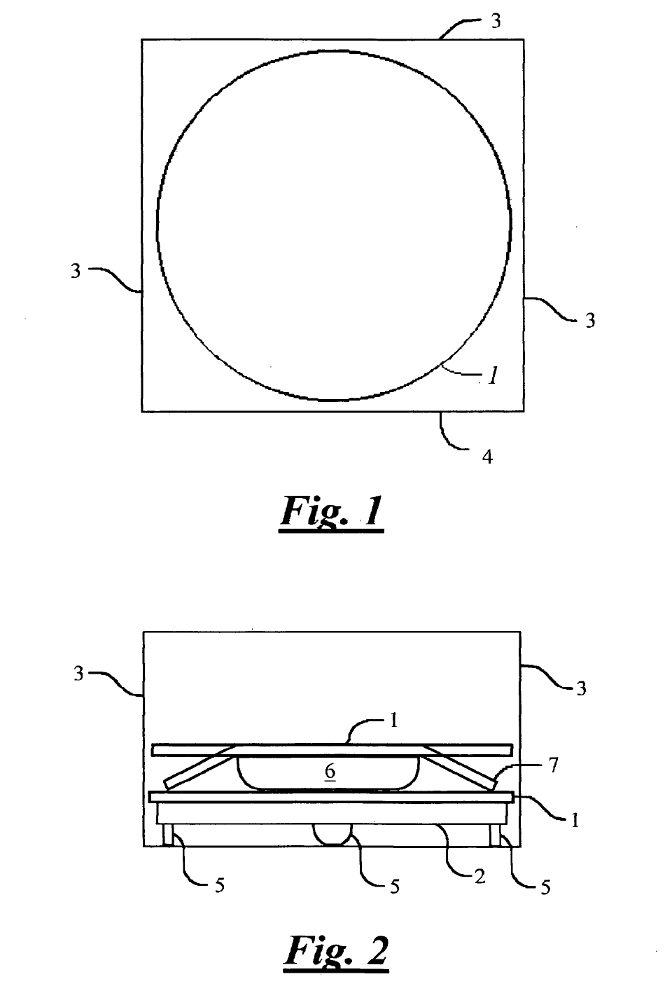

FIGS. 1 and 2 are plan and side views, respectively with the scale of FIG. 2 being exaggerated to clearly show the invention, that illustrate the disposable multipurpose microwave oven splatter protector sheet of the invention embodied as a substantially round sheet 1 of interfacing fabric laid in a flat pattern. FIGS. 1 and 2 additionally illustrate operation of the splatter protector sheet of the invention within a microwave oven. As illustrated in the Figures, the disposable multipurpose microwave oven splatter protector sheet 1 of the invention consists of exclusively and only exactly one single layer of flat, unbroken and continuous unfolded sheet of interfacing fabric that is air permeable, hypoallergenic and that, while being pliant and semi-absorbent of water, remains resistant to tearing, when damp or even completely saturated. Known prior art use of interfacing fabric is limited to the garment, upholstery and craft industries. Interfacing is a supportive fabric that is placed between the facing and garment fabric. Interfacing is commercially available as woven, non-woven or knit fabrics that can be applied by fusing (fusible) or sewing (sew-in). Non-woven interfacings are usually made of polyester, rayon, nylon or a blend of these fibers. The fibers are distributed at random and held together by chemical binders and heat. Because they do not have a yarn direction or grain, non-woven interfacings do not ravel and can be cut in any direction. The choice of polyester, rayon and nylon fibers also results in the interfacing fabric being substantially hypoallergenic which makes it suitable for use in food preparation.

The weight and amount of stretch of non-woven interfacing fabrics vary significantly. Some non-woven interfacing fabrics are relatively stable; others have varying amounts of stretch or give. Non-woven stabilized interfacings do not give or stretch appreciably in any direction. Interfacing weights vary from sheer to quite heavy. The heavy non-woven stabilized interfacings are primarily used for purses, draperies and craft projects, and may be desirable in the garment industry primarily for applications such as buttonholes and waistbands.

Such interfacing fabrics are commercially available, for example, from both Phoenix Fabric Outlet of Phoenix, Ariz. and Real Supply Company of Duvall, Wash.

According to one embodiment of the invention, the disposable arcuate sheet 1 is formed consisting exclusively of only exactly one single layer of a single flat, unfolded continuous and unbroken substantially round sheet of such substantially hypoallergenic non-woven stabilized interfacing material in any commercially available weight ranging from sheer to quite heavy. The sheet 1 is sized to substantially cover the width or diameter of an upper surface of a conventional microwave carousel of a type well-known in the art. The size of the sheet 1 is limited to the overall diameter of the carousel or to slightly over hang the carousel without contacting the interior walls or door of a microwave compartment when it is substantially centered on the carousel. By example and without limitation, the sheet 1 is sized with two different diameters, 10¼ inches and 13¼ inches, that each fit one of the two most common carousel sizes. The sheet 1 is optionally sized with other different diameters determined to fit other common carousel sizes.

In practice, the disposable microwave splatter protection sheet 1 is laid over a carousel platter 2 such that it covers the upper surface of the carousel platter 2. While the sheet 1 is sized to substantially cover the carousel platter 2 without overhang if approximately centered, some overhang (shown) may occur without the sheet 1 contacting the walls 3 and door 4. A result of the sizing of the sheet 1 is that the liquids soaked into the fabric does not contact the walls 3 or door 4, whereby contamination of the walls 3 and door 4 is eliminated. Furthermore, the limited absorbency of the interfacing fabric of which sheet 1 is formed causes liquid spills and splatters to be contained in the fabric where the spill or splatter occurs, rather than wicking throughout the protector device. As such, the microwave oven is protected from contamination by spilled and splattered liquids leaching out of the protector device.

Furthermore, elimination of overhanging material protects the wheels 5 upon which the carousel to rides from interference by the splatter protection sheet 1. The carousel 2 and its drive mechanism (not shown) are protected from damage that such interference may cause.

Each of the two sizes of the disposable multipurpose microwave oven splatter protector sheet of the invention embodied as the substantially round flat sheet 1 of interfacing fabric is appropriate for lying atop an open container or dish of food being rotated on the carousel of the microwave oven.

FIG. 2 additionally illustrates a second one of the disposable multipurpose microwave oven splatter protection sheets 1 of the invention in place over a dish 6 that is set upon the carousel 2 with the first splatter protection sheet 1 intervening.

In practice, the disposable microwave splatter protection sheet 1 is positioned such that it covers an open surface of the food container or dish 6. As discussed herein, the sheet 1 is sized to substantially cover the food container or dish 6 without overhanging the carousel 2, if approximately centered relative to the carousel 2. When the sheet 1 is formed of a relatively heavy and stiff grade of the interfacing material, the sheet 1 may remain a relatively planar disk suspended on the dish 6 (shown) or by food within the dish 6.

Some overhang of the dish 6 (shown) and the carousel 2 may occur without the sheet 1 contacting the walls 3 and door 4. A result of the sizing of the sheet 1 is that the liquids soaked into the fabric does not contact the walls 3 or door 4, whereby contamination of the walls 3 and door 4 is eliminated. Furthermore, the limited absorbency of the interfacing fabric of which sheet 1 is formed causes liquid spills and splatters to be contained in the fabric where the spill or splatter occurs, rather than wicking throughout the protector device. As such, the microwave oven is protected from contamination by spilled and splattered liquids leaching out of the protector device.

When the sheet 1 is formed of a relatively sheer and pliable grade of the interfacing material, it may drape over the edges of the dish 6. If so, the size and rounded shape of the sheet 1 ensure that, if approximately centered relative to the carousel 2, its peripheral edge 7 will remain within the boundaries of the carousel 2.

Furthermore, random distribution of the polyester, rayon, nylon or blended fibers of the interfacing fabric material limit wicking of liquids absorbed by the sheet 1 so that absorbed liquids are contained in sheet 1 and are not transferred to the carousel 2, or the walls 3 or door 4 of the oven compartment.

The disposable microwave splatter protection sheet 1 of the invention thus provides in a device consisting exclusively and only exactly one single substantially continuous and monolithic layer of material a barrier that is proof against food spills, splashes, spatters and spitting during rotation of a carousel, but yet absorbs small amounts of moisture that may over-boil or be spit from a dish. Because of its simple design and inexpensive manufacture, the microwave splatter protection sheet 1 of the invention can be cost effectively disposed without resort to bothersome cleaning. The conventional interfacing fabric used in making the microwave splatter protection sheet 1 of the invention may however be cleaned by conventional water or dry cleaning methods, and according to one embodiment of the invention, the sheet 1 can be machined washed and tumble dried. Therefore, although disposable, the microwave splatter protection sheet 1 can be cleaned and reused, if desired.

While the preferred embodiment of the invention has been illustrated and described, it will be appreciated that various changes can be made therein without departing from the spirit and scope of the invention.

1-20. (canceled)

21: A disposable splatter protection device for a microwave oven, the disposable splatter protection device consisting exclusively of only exactly one single layer of substantially round unbroken and unfolded monolithic sheet of interfacing fabric sized to substantially cover an upper surface of a rotatable carousel of a conventional microwave oven.

22: The disposable splatter protection device of claim 21 wherein the interfacing fabric consists of a non-woven stabilized interfacing fabric of a weight ranging between sheer and heavy and being sized having one of a diameter 10¼ inches and a diameter 13¼ inches.

23: The disposable splatter protection device of claim 22 wherein the sheet of interfacing fabric consists of one or more of polyester, rayon and nylon fibers.

24: The disposable splatter protection device of claim 21 wherein the sheet of interfacing fabric consists of one of a diameter 10¼ inches and a diameter 13¼ inches.

25: The disposable splatter protection device of claim 21 wherein the sheet of interfacing fabric consists of a substantially round-shaped flat pattern of interfacing fabric that is sized having one of a diameter 10¼ inches and a diameter 13¼ inches.

26: The disposable splatter protection device of claim 25 wherein the diameter of the sheet of interfacing fabric is selected to operate with a carousel having a diameter between 10 inches and 14 inches.

27: A splatter protection device for protecting a microwave oven against food spills, splashes, spatters and spitting during rotation of a rotatable carousel, the splatter protection device consisting exclusively of exactly one single flat unfolded and unbroken layer of substantially monolithic and continuous sheet of fabric that is air permeable, water absorbent and hypoallergenic, the sheet of fabric being substantially circular and sized such that, when approximately centered relative to a rotatable carousel of a microwave oven, the sheet of fabric extends into close proximity with the oven walls and closed door without effectively interfering therewith during rotation of the carousel.

28: The disposable splatter protection device of claim 27 wherein the sheet of fabric consists of a substantially round flat pattern consisting of a diameter dimension sized to be one of 10¼ inches and 13¼ inches.

29: The splatter protection device of claim 27 wherein the sheet of fabric consists of a fabric selected to render the splatter protection device disposable.

30: The disposable splatter protection device of claim 33 wherein the fabric consists of a conventional garment interfacing fabric sheet consisting of a sheet of heavy, non-woven stabilized interfacing fabric.

31: The splatter protection device of claim 30 wherein the fabric consists of conventional garment interfacing fabric consisting of one or more of polyester, rayon and nylon non-woven and randomly distributed fibers.

32: The splatter protection device of claim 27 wherein the fabric sheet consists of a fabric that is washable by conventional means.

33: A disposable splatter protection device for a microwave oven, the disposable splatter protection device consisting exclusively of only exactly one single layer of an unbroken and unfolded continuous arcuate sheet of interfacing fabric material sized to substantially cover an upper surface of a rotatable carousel of a conventional microwave oven.

34: The splatter protection device of claim 33 wherein the interfacing fabric consists of a non-woven stabilized interfacing fabric of a weight ranging between sheer and heavy, and further consists of one of a diameter 10¼ inches and a diameter 13¼ inches.

35: The splatter protection device of claim 34 wherein the sheet of interfacing fabric consists of one or more of polyester, rayon and nylon fibers.

36: The splatter protection device of claim 33 wherein the sheet of interfacing fabric consists of one of a diameter 10¼ inches and a diameter 13¼ inches.

37: The splatter protection device of claim 33 wherein the arcuate sheet of interfacing fabric consists of a substantially round-shaped flat pattern of interfacing fabric consisting of a diameter of either 10¼ inches or 13¼ inches.
